(19) United States
(12) Patent Application Publication
(10) Pub. No.: US 2025/0062564 A1
(43) Pub. Date: Feb. 20, 2025

(54) ELECTRICAL TERMINAL WITH OUTER SHIELD

(71) Applicant: Aptiv Technologies AG, Schaffhausen (CH)

(72) Inventors: Gert Droesbeke, ERKRATH (DE); Bartlomiej SIWEK, Brzezinka (PL)

(21) Appl. No.: 18/799,026

(22) Filed: Aug. 9, 2024

Related U.S. Application Data
(60) Provisional application No. 63/532,710, filed on Aug. 15, 2023.

(30) Foreign Application Priority Data
Jun. 28, 2024 (EP) 24185333.2
Aug. 7, 2024 (EP) 24193343.1

(51) Int. Cl. H01R 13/506; H01R 13/6581; H01R 43/18

(52) U.S. Cl. CPC H01R 13/506; H01R 13/6581; H01R 43/18

(57) ABSTRACT

The disclosure shows a connector assembly including at least one signal transmission wire terminated to a signal contact, housed within a connector housing consisting of a first and second connector half with latches for interlocking the first and second connector halves. Additionally, a metal sleeve is fitted around and securely locked onto the connector housing. This assembly provides a robust and secure connection for signal transmission, ensuring reliable performance and durability in various applications.

### CROSS-REFERENCE TO RELATED APPLICATION

This application claims benefit of priority to European Patent Application No. 24193343.1 filed on Aug. 7, 2024, and European Patent Application No. 24185333.2 filed on Jun. 28, 2024. This application further claims benefit of priority to U.S. Provisional Patent Application No. 63/532,7120 filed on Aug. 15, 2023. The entire disclosure of each of these priority documents is hereby incorporated by reference.

### TECHNICAL FIELD OF THE INVENTION

This invention relates to a high-speed data connector assembly and a method for assembling the high-speed data connector assembly.

### BACKGROUND

Examples of high-speed data connector assemblies for differential pair signal transmission are sold by a company called “Rosenberger Hochfrequenztechnik GmbH & Co. KG” under the trademark H-MTD®-High-Speed Modular Twisted-Pair Data.

Applications for such high-speed data connectors are 4K camera systems, autonomous driving, radar, lidar, high resolution displays and rear seat entertainment. Versions of such connectors are designed to operate at frequencies up to 20 GHz while having a small package size.

In such high-speed applications, every tenth of a millimeter of the interconnection channel and of the signal connectors should be within a certain data transmission (differential) impedance bandwidth (typically 100±5Ω) and should be matched to preceding and succeeding sections. To this end, in each of these sections, metal portions of an inner contact or signal contact and an outer contact or shielding, insulating material of an insulating element and any air gaps should be balanced in size and position with respect to each other. There is also a need for these components to meet other non-signal-integrity requirements, in particular mechanical requirements. For example, the high-speed data connector assembly should be securely closed during assembly and remains securely closed during operation. In particular, the closure has to be resistant to vibration. To achieve a secure closure of the high-speed data connector assembly, an easy and trustable assembling process should be provided.

Accordingly, there is a need for a high-speed data connector assembly that is easy and secure to assemble and that provides a secure closure during operation.

### SUMMARY

An aspect of the invention relates to a connector assembly including at least one signal transmission wire with a signal contact terminated to it; wherein the terminal is preferably a male terminal; a connector housing retaining the at least one signal contact and including first and second connector halves; wherein the first and second connector halves include connecting means for connecting the two halves with each other; and a metal sleeve fitted around and locked onto the connector housing.

The signal transmission wire provides the pathway for electrical signals, while the connector housing protects the connection and ensures proper alignment of the signal contacts. The connecting means in the first and second connector halves allow for easy assembly and disassembly, facilitating maintenance or replacement. The metal sleeve enhances the durability and electromagnetic shielding of the connector, protecting it from physical damage and interference. This design is advantageous in high-frequency applications where signal integrity is important.

A further embodiment is realized when the first and second connector halves include connecting means configured for a two-step assembly process, the means including pre-latching components configured to engage with each other by moving the first and second connector halves perpendicular to the mating axis, and final-latching components configured to engage with each other by moving the first connector half relative to the second connector half parallel to the mating axis.

Such a two-step assembly process enhances the case and security of the connector assembly. The pre-latching components allow for an initial alignment and temporary hold of the first and second connector halves, making it easier to handle and position them correctly. Once the pre-latching is arranged, the final-latching components can ensure a robust and stable connection by locking the first and second connector halves together along the mating axis. This method is beneficial in environments where precise and reliable connections are necessary, e.g., where vibrations and movements could otherwise disrupt the connection. The two-step process also simplifies the assembly procedure, reducing the risk of misalignment and improving overall efficiency.

This embodiment is further improved when the final-latching component of the first connector half includes at least one latching aperture and the final-latching component of the second connector half includes at least one latching arm, having a dimension such that the latching arm does not fit into the latching aperture when the connecting means are moved perpendicular to mating direction.

Such a design feature ensures that the first and second connector halves can only be fully secured when properly aligned along the mating axis. During the initial perpendicular movement, the latching arm remains outside the latching aperture, preventing premature or incorrect locking. This prevents potential misalignment and ensures that the final locking mechanism engages correctly only when the first and second connector halves are moved parallel to the mating axis. This configuration enhances the reliability and integrity of the connection, making it particularly useful in applications requiring precise and secure connections. The defined dimensions of the latching arm and aperture provide a fail-safe mechanism, ensuring that the assembly process follows the intended two-step sequence, thereby reducing assembly errors and improving overall product quality.

This can be further improved when the final-latching component of the second connector half includes at least one latching arm and the latching arm includes a latching hook, which hook includes a corrugated locking surface and the latching aperture includes a complimentary corrugated locking surface.

Such an enhanced final-latching mechanism provides a more secure and stable connection. The corrugated locking surfaces on both the latching hook and the latching aperture interlock when engaged, increasing the friction and preventing accidental disengagement. This design is advantageous in environments subject to vibrations or mechanical stresses, where maintaining a stable connection is important. The corrugated surfaces ensure a tighter grip, enhancing the durability and longevity of the connection. Additionally, this feature simplifies the assembly process by providing clear tactile feedback when the first and second connector halves are properly secured, thereby reducing the likelihood of incomplete or incorrect assembly.

This embodiment can be improved when the hook is arranged on the free end of the latching arm protruding transvers from the latching arm, and the corrugated locking surface is arranged on the underside of the protruding part of the hook.

Such a configuration ensures a more effective and secure locking mechanism. The transverse positioning of the hook on the latching arm allows it to engage more effectively with the corresponding latching aperture. The corrugated locking surface on the underside of the protruding hook part enhances the grip and stability of the connection, preventing it from disengaging due to vibrations or mechanical stresses. This design is beneficial in applications where robust and reliable connections are necessary. The transverse arrangement also facilitates casier alignment and engagement during the assembly process, providing a clear and secure locking action. This design feature contributes to the overall durability and reliability of the connector assembly, ensuring consistent performance in demanding environments.

This can be even further improved when the corrugated locking surfaces are configured to provide a snap-fit connection when moved parallel to the mating axis.

Such a snap-fit connection enhances the case and reliability of the assembly process. As the first and second connector halves are moved parallel to the mating axis, the corrugated locking surfaces on the latching hook and aperture engage with a snapping action, providing an audible and tactile confirmation of a secure connection. This snap-fit mechanism ensures a firm and stable lock, which is advantageous in environments subject to mechanical vibrations or shocks. The snap-fit design also simplifies assembly and disassembly, allowing for quick and easy connections without the need for additional tools or fasteners. This feature improves assembly efficiency and reduces the risk of improper connections, enhancing the overall reliability and performance of the connector assembly.

Another embodiment of the invention is realized when the final-latching component of the first connector half includes at least one latching aperture and wherein the latching aperture is provided in the housing of the first connector half in form of an open slit in the housing wall, which slit is open in a direction opposite to the mating direction.

Such an open slit design of the latching aperture facilitates easier and more secure engagement of the latching arm's hook. As the first and second connector halves are assembled, the latching arm is guided into the slit, ensuring proper alignment and engagement of the corrugated locking surfaces. The orientation of the slit, opening opposite to the mating direction, prevents accidental disengagement and ensures that the connection remains secure under mechanical stress or vibrations. This design is useful in applications where the connector assembly may be subjected to repeated connection and disconnection cycles. The open slit provides a clear path for the latching arm, reducing the risk of misalignment and enhancing the overall reliability and durability of the connector assembly.

Further improvement is achieved when the first and the second connector half include sliding surfaces to enable a sliding movement between the first connector half and the second connector half, configured and dedicated to sliding the first and second connector halves into an interconnected configuration.

Such sliding surfaces are engineered to ensure smooth and precise alignment during the assembly process. As the first and second connector halves are brought together, the sliding surfaces guide them into the correct position, reducing the effort required to achieve a secure connection. This feature is beneficial in applications where quick and reliable assembly is important. The sliding surfaces help prevent misalignment and ensure that the final-latching components engage correctly, enhancing the overall robustness and reliability of the connection. Additionally, the sliding mechanism can reduce wear and tear on the connector components, extending the lifespan of the assembly and maintaining performance over repeated use. This design simplifies the assembly process, making it more efficient and less prone to errors, which is advantageous in both manufacturing and maintenance contexts.

This can be further improved when the metal sleeve includes a locking means to form a locked condition between the metal sleeve and at least one of the first connector half and the second connector half, wherein the locking means preferably includes at least one single ended locking lance and/or at least one double ended locking bow.

Such a locking means on the metal sleeve can enhance the stability and security of the connector assembly. The single-ended locking lance and double-ended locking bow are designed to engage with corresponding features on the first and second connector halves, providing a secure attachment that prevents the sleeve from shifting or detaching during use. This is advantageous in applications where the connector assembly is exposed to mechanical stresses or vibrations. The locking mechanism can ensure that the metal sleeve remains in place, contributing to the overall durability and electromagnetic shielding of the connector. The presence of these locking features also simplifies the assembly process by providing a clear and secure method to attach the metal sleeve, thereby reducing the risk of improper installation and enhancing the reliability and performance of the connector assembly.

This embodiment is further improved, when the locking means includes a snap fit and/or a metal spring.

Such an inclusion of a snap-fit and/or a metal spring in the locking mechanism further enhances the case and reliability of securing the metal sleeve to the first and second connector halves. The snap-fit mechanism provides a quick and intuitive method to attach the metal sleeve, ensuring an audible and tactile confirmation when the sleeve is properly locked in place. This feature reduces assembly time and minimizes the potential for incorrect installation. The metal spring adds an extra layer of security by applying consistent pressure, maintaining the sleeve's position even under vibrations or mechanical stress. This combination is beneficial in high-vibration environments where maintaining a stable and secure connection is important. The snap-fit and metal spring work together to ensure that the metal sleeve remains firmly attached, enhancing the overall durability, electromagnetic shielding, and performance of the connector assembly.

Further improvement is achieved when at least one of the first connector half and the second connector half includes a locking means to form a locked condition with the metal sleeve, wherein the locking means preferably includes a recess and/or a protrusion, wherein the protrusion is preferably a hook.

Such an integration of a recess and protrusion mechanism, e.g., with the protrusion designed as a hook, ensures a reliable and secure attachment of the metal sleeve to the first and second connector halves. The recess provides a defined space for the hook to engage, creating a stable and locked condition that prevents the sleeve from shifting or detaching during operation. This feature is especially advantageous in environments subject to mechanical stress where maintaining the integrity of the connection is important. The hook design allows for easy engagement and disengagement, simplifying the assembly and maintenance processes. This mechanism enhances the overall robustness of the connector assembly, ensuring that the metal sleeve remains securely attached, providing necessary protection and electromagnetic shielding. This design also helps in maintaining the performance and longevity of the connector by preventing accidental disconnections and ensuring a consistently reliable connection.

Further improvement is achieved when the metal sleeve includes at least one embossment, preferably on the outside of the metal sleeve.

Such embossments can ensure compatibility with standardized cavities, simplifying manufacturing processes by eliminating the need for various curvatures and steps in the sleeve cross-section, thereby reducing production complexity and costs. The design maintains the inside of the sleeve close to the signal contacts, improving differential impedance matching and enhancing signal integrity. Additionally, placing polarization and forward stop features on the metal sleeve, rather than on the housing halves, increases the metal available for shielding, providing better electromagnetic shielding and improved impedance matching. This integration enhances the overall performance of the connector assembly, particularly in high-speed data transmission and/or other sensitive electronic equipment applications. In a preferred embodiment, these embossments offer practical benefits, including manufacturing efficiency, cost reduction, and enhanced performance, making the connector design robust and reliable for various demanding applications.

Further improvement is achieved when the metal sleeve includes two slots perpendicular to the mating axis and wherein the area between the slots is elevated, configured and dedicated to form a latched connection with an elevated portion of at least one connector half.

Such a design offers several benefits: the elevated area between the slots provides a secure latching point, ensuring that cable pull stress is transferred to a housing collar behind the sleeve rather than directly to the metal sleeve, preventing detachment under tension. The integration of a housing collar behind the metal sleeve allows the primary and secondary lock latches of the cavity to hook securely behind this plastic collar, ensuring that cable pulls stress the housing first, thus protecting the metal sleeve. This arrangement enhances the structural integrity of the connector assembly, making it more resilient to mechanical stresses, which is beneficial in environments with frequent handling, movement, or high tension. These slots with an elevated area can improve the connector assembly's durability and resistance to mechanical stress, ensuring that cable pull forces are absorbed by the housing first, thereby protecting the metal sleeve and extending the lifespan and reliability of the connector assembly in demanding applications.

Further improvement can be achieved when at least one connector half includes at least one triangular shaped elevation on the outside, configured and dedicated to being pressed under the metal sleeve after assembly.

The triangular-shaped elevations on the first and second connector halves offer important benefits, ensuring a secure locking mechanism without any clearance. The on-molded triangular elevations and/or additional interference ribs can tightly lock the metal sleeve onto the assembled housing halves, preventing any movement or shifting and maintaining the connection's integrity and stability. By pressing the triangular elevations under the metal sleeve, the design provides additional contact points and pressure, enhancing the assembly's overall stability and robustness, especially beneficial in applications subject to vibrations or physical stresses. This secure locking mechanism improves performance and extends the connector assembly's lifespan, making it ideal for environments where reliable and durable connections are important. The triangular-shaped elevations enhance the metal sleeve's locking mechanism, ensuring a stable connection and improving the connector assembly's durability and performance for demanding applications.

Another embodiment of the invention is a method of assembling a connector assembly including the steps of: a) providing a connector assembly according to any of the preceding claims; b) arranging the at least one signal transmission cable into the one half; c) a pre-latching step by moving the first and second connector halves perpendicular to the mating axis; d) a final latching step by moving the first connector half relative to second connector half parallel to the mating axis; and e) sliding the metal sleeve over first and second connector half; wherein preferably after step d), the first connector half and the second connector half are interconnected; and wherein preferably after step e) the metal sleeve is interlocked with at least one of the first and second connector half.

Such an assembly method for the connector offers several benefits, ensuring a sequential and secure assembly that enhances precision and reliability. By arranging the signal transmission cable into one half first, the method maintains the integrity of the signal path and improves overall performance. The pre-latching step ensures initial alignment and hold, while the final latching step secures the first and second connector halves together, resulting in a robust and reliable connection necessary for stable and durable applications. Sliding the metal sleeve over the assembled halves as the final step simplifies the process, providing additional mechanical protection and electromagnetic shielding. The interlocking feature of the metal sleeve with at least one half ensures it remains securely in place, even under mechanical stress. This method offers a practical and efficient way to assemble the connector, ensuring all components are properly aligned and fastened, enhancing the reliability and performance of the connector assembly for demanding applications.

### BRIEF DESCRIPTION OF THE DRAWINGS

The present invention is now described, by way of example with reference to the accompanying drawings, in which:

FIG. 1 illustrates a connector assembly according to the invention before assembly in an isometric view according to some embodiments.

FIG. 2A shows the first connector half of FIG. 1 in an isometric view according to some embodiments.

FIG. 2B shows the connector half of FIG. 2A in a detailed isometric view according to some embodiments.

FIG. 3A shows the second connector half of FIG. 1 in an isometric view according to some embodiments.

FIG. 3B shows the connector half of FIG. 3A in a detailed isometric view according to some embodiments.

FIG. 4 depicts a metal sleeve according to the invention in an isometric view according to some embodiments.

FIG. 5 illustrates another connector assembly according to the invention before assembly of the metal sleeve in an isometric view according to some embodiments.

FIG. 6 depicts a metal sleeve according to the invention assembled on a connector half in a top view according to some embodiments.

FIG. 7 shows another connector assembly after assembly in a top view according to some embodiments.

FIG. 8 depicts another embodiment of the connector assembly in an isometric view according to some embodiments.

FIG. 9 illustrates the connector assembly of FIG. 8 during the assembly of the metal sleeve in an isometric view according to some embodiments.

FIGS. 10A and 10B show the assembly of the metal sleeve of FIG. 9 in a cross-sectional view according to some embodiments.

### DETAILED DESCRIPTION

The subsequent sections provide a detailed description of the invention, referencing the accompanying illustrations for clarity. The descriptions represent examples only and are not intended to limit the invention's scope. Identical reference numerals across the figures and text denote the same components. The illustrations may not reflect actual size or scale; their dimensions, proportions, and depictions of elements might be enhanced for better understanding and visual convenience.

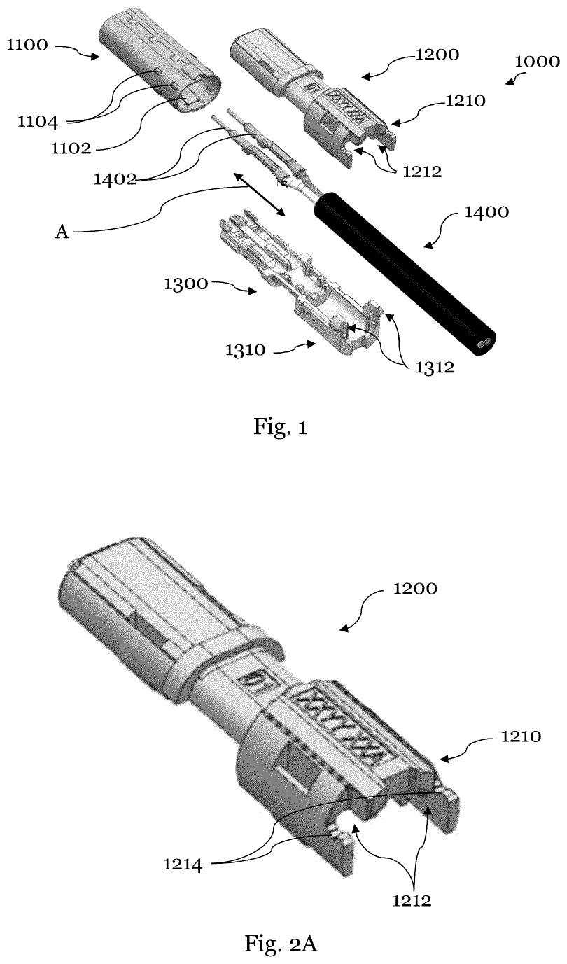

FIG. 1 illustrates a connector assembly according to the invention before assembly in an isometric view. The connector assembly 1000 includes a metal sleeve 1100, which includes a metal spring 1102 and embossments 1104 on the outside. A first connector half 1200 and a second connector half 1300 form the connector housing. The first connector half 1200 includes connecting means 1210 and the connecting means 1210 include two latching apertures 1212. The second connector half 1300 includes connecting means 1310 with two latching arms 1312. The wire 1400 includes two terminals 1402. The mating axis A gives the mating direction of the connector assembly.

When assembling the connector assembly, at first the terminals 1402 are seated in the second connector half 1300, after which the first connector half 1200 is moved onto the second connector half 1300 in a direction perpendicular to the mating axis A into a pre-latched position. Secondly, the two connector halves are moved relative to each other into a final-latching position in the direction of the mating axis. The final-latching position is reached when the latching arms are seated inside the latching apertures 1212. Afterwards, the metal sleeve 1100 is slid over the latched connector halves, so that the metal spring 1102 forms a form fit connection with one of the first and second connector halves.

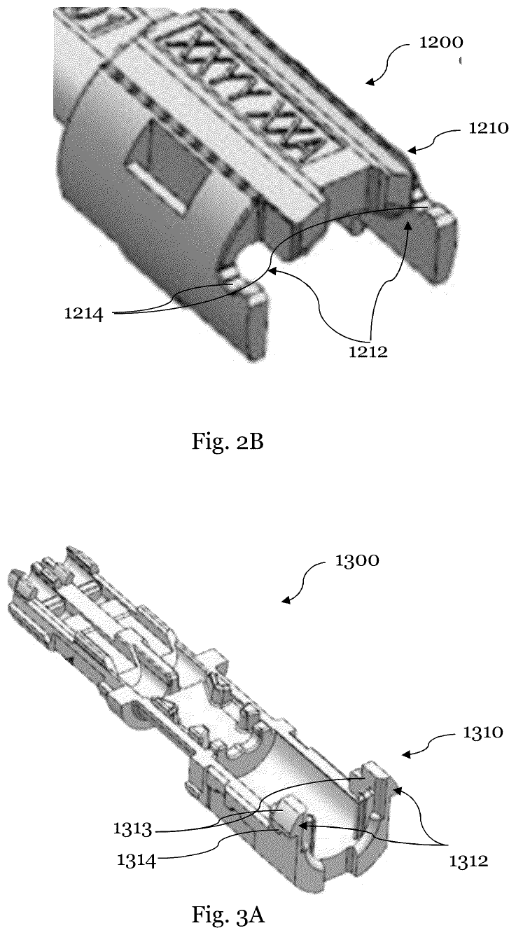

FIG. 2A shows the first connector half 1200 of FIG. 1 in an isometric view. The connecting means 1210 includes two latching apertures 1212 and each latching aperture 1212 includes a corrugated locking surface 1214.

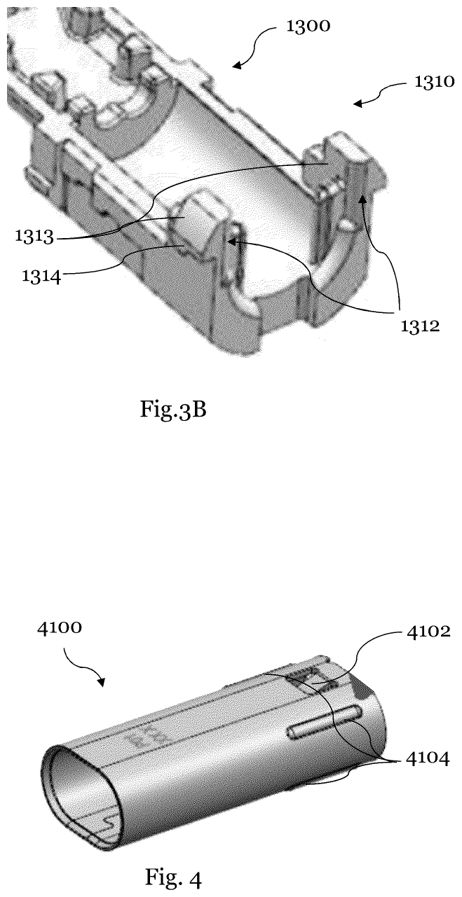

The corrugated locking surfaces 1214 within the latching apertures 1212 provide additional friction and locking strength, as the corrugated surfaces can engage with corresponding structures on the second connector half (shown in FIG. 3A), creating a reliable interlock that maintains signal integrity and mechanical stability.

FIG. 2B shows the connector half of FIG. 2A in a detailed isometric view.

FIG. 3A shows the second connector half 1300 of FIG. 1 in an isometric view. The connecting means 1310 includes two latching arms 1312 and each latching arm 1312 includes a latching hook 1313 protruding transverse from the latching arm, with a corrugated locking surface 1314. The corrugated locking surface is arranged on the underside of the protruding part of the hook.

The corrugated locking surfaces 1314 on the latching arms 1312 can engage with the corresponding corrugated surfaces within the latching apertures of the first connector half (shown in FIG. 2B) in form of a snap-fit connection when moved parallel to the mating axis. This engagement can create a strong interlock that resists mechanical stress and vibrations, ensuring that the connector assembly remains securely fastened.

FIG. 3B shows the connector half of FIG. 3A in a detailed isometric view.

FIG. 4 depicts a metal sleeve 4100 according to the invention in an isometric view. The metal sleeve includes four embossments 4104 arranged on the outside of the sleeve and extending in the axial direction of the sleeve 4100 and a metal spring 4102.

The embossments 4104 can improve the grip and alignment of the sleeve 4100, ensuring it fits securely over the first and second connector halves without any clearance. The external placement of the embossments simplifies the manufacturing process while maintaining compatibility with standardized cavities. This design also eliminates the need for complex curvatures and steps in the sleeve cross-section, reducing production costs. The metal spring 4102 integrated into the sleeve can ensure a tight fit around the first and second connector halves, providing consistent pressure and enhancing the mechanical stability of the assembly. This spring mechanism prevents the sleeve from shifting or detaching under mechanical stress or cable pull, contributing to the overall durability and reliability of the connector assembly. By maintaining the inside of the sleeve close to the signal contacts, the design can improve differential impedance matching and signal integrity. Additionally, the external embossments can allow for the integration of polarization and forward stop features directly into the metal sleeve, rather than the housing halves, providing better electromagnetic shielding and further improving differential impedance matching.

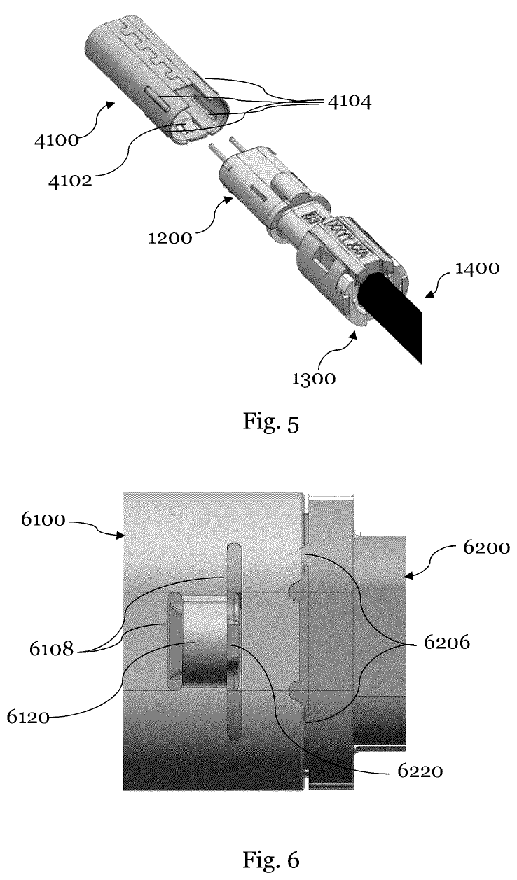

FIG. 5 illustrates another embodiment of the invention before assembly of the metal sleeve 4100 in an isometric view. The connector halves 1200 and 1300 are already arranged in the final latching position around the wire 1400 after the two-step assembly process. The metal sleeve 4100 can simply be slid over the first and second connector halves in this configuration.

The connector halves 1200 and 1300 are securely latched together around the wire 1400 following the two-step assembly process. This process involves initially aligning and pre-latching the first and second connector halves by moving them perpendicular to the mating axis, followed by a final latching step moving them parallel to the mating axis. This ensures a robust and stable connection between the first and second connector halves. Once the first and second connector halves are in the final latching position, the metal sleeve 4100 can be easily slid over them. The design of the sleeve 4100, with its four axial embossments 4104 and metal spring, allows it to fit securely around the latched connector halves, providing additional mechanical stability and electromagnetic shielding.

FIG. 6 depicts another metal sleeve 6100 according to the invention assembled on a connector half in a top view. The metal sleeve 6100 includes two slots 6108 and an elevated portion 6120 between the slots 6108. The metal sleeve is arranged over a first connector half 6200 and the connector half 6200 includes two triangular shaped elevations 6206 and an elevated portion 6220. The elevated portion 6220 of the connector half is arranged directly under the elevated portion 6120 of the metal sleeve 6100.

The elevated portion 6120 of the metal sleeve fits directly over the elevated portion 6220 of the first connector half, ensuring secure interlocking and preventing any movement or displacement during use. The triangular-shaped elevations 6206 on the connector half are pressing against the sleeve to create a tight fit without clearance, thus enhancing the stability and mechanical integrity of the connector assembly and making it resistant to vibrations and physical stresses. The interlocking and tight fit provided by the elevated portions 6120 and 6220 arranged inside one another and triangular elevations 6206 ensure the metal sleeve remains securely attached, maintaining the overall durability and performance of the connector assembly.

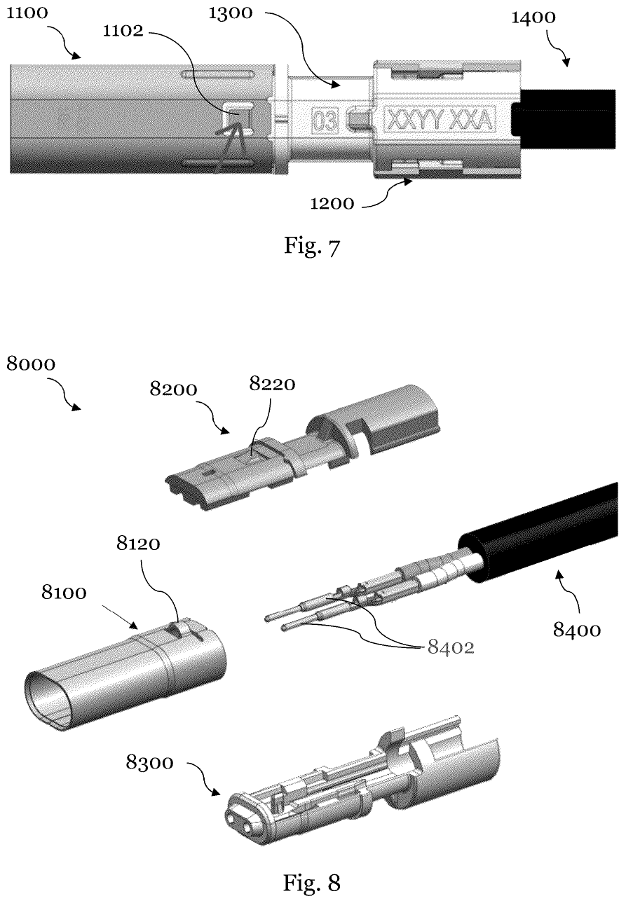

FIG. 7 shows the connector assembly of FIG. 5 after assembling the metal sleeve 1100 in a bottom view. The metals sleeve is slid over the assembled connector halves 1200, 1300 which house the wire 1400. The metal sleeve 1100 includes a metal spring 1102, which forms a form-locked condition with the connector half 1300.

The metal spring within the sleeve creates a form-locked condition with connector half 1300, ensuring the metal sleeve remains securely in place, preventing any displacement or loosening during use. This can enhance the assembly's stability and durability after sliding the metal sleeve over the assembled connector halves 1200, 1300, making the connector assembly resistant to vibrations and physical stresses. Additionally, the metal sleeve provides mechanical protection and enhances electromagnetic shielding for the housed wire 1400, ensuring signal integrity and performance. The assembly process is simplified by sliding the metal sleeve over the first and second connector halves, with the form-locked condition created by the metal spring ensuring a secure fit without needing additional fasteners.

FIG. 8 depicts another embodiment of the connector assembly in an isometric view. The connector assembly 8000 includes a metal sleeve 8100, which includes an elevated portion 8120. A first connector half 8200 and a second connector half 8300 form the connector housing. The first connector half 8200 includes an elevated portion 8220, which can fit into the elevated portion 8120 of the metal sleeve to form a form-fit connection, which inhibits the movement of the metal sleeve after mating it with the connector housing. The wire 8400 includes two male pin terminals 8402.

Such a design provides several benefits: the form-fit connection between the elevated portions 8120 and 8220 creates a secure locking mechanism that prevents any movement of the metal sleeve, enhancing stability and durability under mechanical stress or vibrations. Additionally, the wire and male terminals are securely housed and protected by the metal sleeve, offering mechanical protection, and improved electromagnetic shielding for high signal integrity and performance.

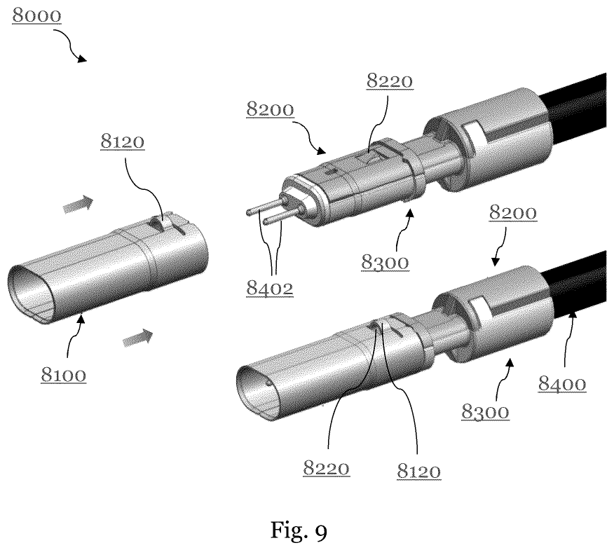

FIG. 9 illustrates the connector assembly of FIG. 8 during the assembly of the metal sleeve in an isometric view. The first connector half 8200 and the second connector half 8300 form the connector housing by enclosing the wire and the terminals 8402. After connecting the first connector half 8200 and the second connector half 8300 to form the connector housing, the metal sleeve 8100 is slid over the housing, such that the elevated portion 8220 of the second connector half forms a form-fit connection with the elevated portion 8120 of the metal sleeve 8100, inhibiting movement of the metal sleeve 8100 and thus securing it on the housing.

Such a form-fit connection secures the metal sleeve firmly onto the connector housing, preventing any movement or displacement during use. The assembly process can ensure that the wire and terminals are securely housed, and the metal sleeve provides additional mechanical protection and electromagnetic shielding, enhancing signal integrity and overall performance. This design simplifies the assembly process and ensures a robust and reliable connection.

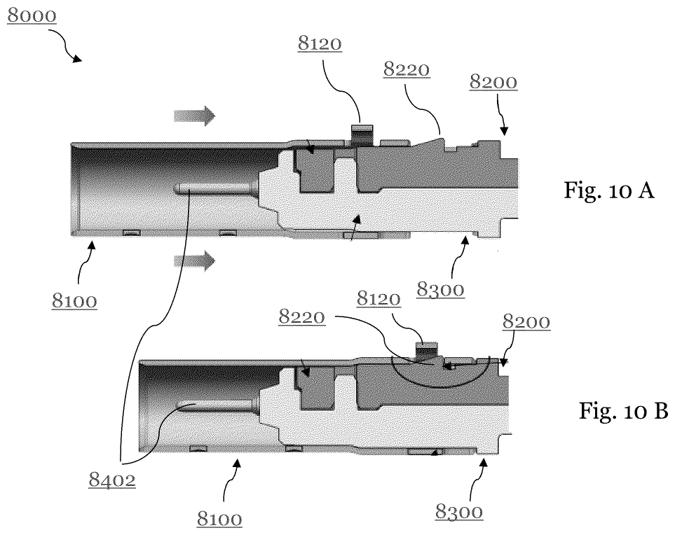

FIGS. 10A and 10B show the assembly of the metal sleeve of FIG. 9 in a side view. The first connector half 8200 and the second connector half 8300 form the connector housing by enclosing the wire and the terminals 8402. Once the first and second connector halves 8200, 8300 are joined to create the housing, the metal sleeve 8100 is slid over the housing. The elevated portion 8220 of the second connector half 8200 then forms a form-fit connection with the elevated portion 8120 of the metal sleeve 8100 preventing movement and thereby securing the sleeve on the housing.

The form-fit connection prevents the metal sleeve from moving, securing it firmly onto the housing. The benefits of this design include a secure locking mechanism that prevents displacement or loosening during use and additional mechanical protection and electromagnetic shielding provided by the metal sleeve, which enhances signal integrity and performance.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector assembly comprising:
at least one signal transmission wire;
a signal contact terminated to the at least one signal transmission wire;
a connector housing retaining the signal contact and comprising a first connector half and a second connector half having connecting means for connecting the first and second connector halves with each other; and
a metal sleeve fitted around and locked onto the connector housing.

2. The connector assembly according to claim 1, wherein the signal contact comprises a male terminal.

3. The connector assembly according to claim 1, wherein the first and second connector halves comprise connecting means configured for a two-step assembly process, the connecting means comprising pre-latching components configured to engage with each other by moving the first and second connector halves perpendicular to a mating axis, and final-latching components configured to engage with each other by moving the first connector half relative to the second connector half parallel to a mating axis.

4. The connector assembly according to claim 3, wherein the final-latching components of the first connector half comprise at least one latching aperture and the final-latching components of the second connector half comprise at least one latching arm having a dimension such that the at least one latching arm does not fit into the at least one latching aperture when the connecting means are moved perpendicular to mating direction.

5. The connector assembly according to claim 4, wherein the final-latching components of the second connector half comprise at least one latching arm and the at least one latching arm comprises a latching hook, wherein the latching hook comprises a corrugated locking surface and the at least one latching aperture comprises a complimentary corrugated locking surface.

6. The connector assembly according to claim 5, wherein the latching hook is arranged on a free end of the at least one latching arm protruding transversely from the at least one latching arm and the corrugated locking surface is arranged on an underside of a protruding part of the latching hook.

7. The connector assembly according to claim 6, wherein the corrugated locking surfaces are configured to provide a snap-fit connection when moved parallel to the mating axis.

8. The connector assembly according to claim 3, wherein the final-latching components of the first connector half comprise at least one latching aperture and wherein the at least one latching aperture is provided in the first connector half in form of an open slit in a housing wall in a direction opposite to a mating direction.

9. The connector assembly according to claim 3, wherein the metal sleeve comprises two slots arranged perpendicularly to the mating axis and wherein an area between the two slots is elevated and wherein the two slots are configured to form a latched connection with an elevated portion of at least one connector half.

10. The connector assembly according to claim 1, wherein the first and second connector halves comprise sliding surfaces configured to enable a sliding movement between the first connector half and the second connector half and configured to sliding the first and second connector halves into an interconnected configuration.

11. The connector assembly according to claim 1, wherein the metal sleeve comprises a locking means to establish a locked condition between the metal sleeve and at least one of the first connector half and the second connector half.

12. The connector assembly according to claim 11, wherein the locking means comprises at least one single ended locking lance and/or at least one double ended locking bow.

13. The connector assembly according to claim 11, wherein the locking means comprises a snap fit and/or a metal spring.

14. The connector assembly according to claim 1, wherein at least one of the first connector half and the second connector half comprises a locking means to form a locked condition with the metal sleeve.

15. The connector assembly according to claim 14, wherein the locking means comprises a recess and/or a protrusion, wherein the protrusion comprises a hook.

16. The connector assembly according to claim 1, wherein the metal sleeve comprises at least one embossment.

17. The connector assembly according to claim 1, wherein at least one connector half comprises at least one triangular shaped elevation (1206) on an outside of the at least one connector half configured and dedicated to being pressed under the metal sleeve after assembly.

18. A method of assembling a connector assembly comprising:
providing a connector assembly having:
at least one signal transmission wire;
a signal contact terminated to the at least one signal transmission wire;
a connector housing retaining the signal contact and comprising a first connector half and a second connector half having connecting means for connecting the first and second connector halves with each other; and
a metal sleeve fitted around and locked onto the connector housing;
arranging the at least one signal transmission wire into the first connector half;
moving the first and second connector halves perpendicular to a mating axis, moving the first connector half relative to second connector half parallel to a mating axis; and
sliding the metal sleeve over the first and second connector halves.

19. The method according to claim 18, wherein the first connector half and the second connector half are interconnected after moving the first connector half relative to second connector half parallel to the mating axis.

20. The method according to claim 18, wherein the metal sleeve is interlocked with at least one of the first and second connector halves after sliding the metal sleeve over the first and second connector halves.
